(19) United States
(12) Patent Application Publication
(10) Pub. No.: US 2010/0044590 A1
(43) Pub. Date: Feb. 25, 2010

(54) LASER PROCESSING METHOD

(75) Inventor: Chikara Aikawa, Ota-ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/500,069

(22) Filed: Jul. 9, 2009

(30) Foreign Application Priority Data
Aug. 20, 2008 (JP) 2008-211293

(51) Int. Cl. G21K 5/00

(52) U.S. Cl. 250/492.2

(57) ABSTRACT

A laser processing method for processing a wafer including a substrate layer and a device layer composed of a plurality of devices formed on the front side of the substrate layer, wherein a laser beam is applied to the wafer from the back side in a defocused condition where the focal position of the laser beam is spaced apart from the surface position of the substrate layer on the back side by a predetermined distance.

### BACKGROUND OF THE INVENTION

1. Field of the Invention

The present invention relates to a laser processing method for processing a semiconductor wafer by using a laser beam, and more particularly to a laser processing method for applying a laser beam to a semiconductor wafer along planned division lines formed thereon to thereby divide the wafer along the planned division lines.

2. Description of the Related Art

An optical device wafer is configured by forming a gallium nitride compound semiconductor layer (EPI layer) on the surface of a sapphire substrate or the like in a plurality of regions partitioned by a plurality of streets (planned division lines) formed on the sapphire substrate, thereby forming a plurality of optical devices such as light emitting diodes and laser diodes in these regions. The optical device wafer is divided along these streets into the individual optical devices, which are widely used in electric equipment. Conventionally, a cutting apparatus including a cutting blade rotating at a high speed is used to cut such a semiconductor device wafer along the streets. However, since the sapphire substrate is a hard-to-grind substrate having a high Mohs hardness, a processing speed must be reduced to cause a reduction in productivity.

In recent years, a method of cutting a semiconductor wafer by using a laser beam has also been developed. For example, Japanese Patent Laid-open No. Hei 10-305420 discloses a laser processing method such that a laser beam is applied to a workpiece formed from a single crystal oxide to dissociate and evaporate the molecules of the single crystal oxide by a photochemical reaction, thereby forming a laser processed groove at a predetermined position on the workpiece. By applying an external force along this laser processed groove, the workpiece is cleaved.

In the case of forming a laser processed groove on a semiconductor device wafer, a laser beam is applied to the wafer from the back side thereof (the substrate layer side), so as to prevent that the optical devices formed on the front side of the wafer (the device layer side) may be damaged by the laser beam. In this case, a laser beam having an absorption wavelength to the substrate layer is used. However, not all of the energy of the laser beam is absorbed by the substrate layer, but the remaining energy of the laser beam not absorbed by the substrate layer is released from the substrate layer to the device layer of the wafer. Accordingly, there is a possibility that the optical devices formed in the device layer may be damaged or reduced in quality by the laser beam not absorbed by the substrate layer, but transmitted through the substrate layer to the device layer.

### SUMMARY OF THE INVENTION

It is therefore an object of the present invention to provide a laser processing method which can suppress the damage to the optical devices formed in the device layer of a wafer in applying a laser beam along the streets formed on the substrate layer of the wafer, thereby giving the wafer any means for triggering the division of the wafer by the application of an external force.

In accordance with an aspect of the present invention, there is provided a laser processing method using a laser processing apparatus including holding means having a holding surface for holding a wafer and laser beam applying means having focusing means for applying a laser beam to the wafer held by said holding means, said wafer including a substrate layer, and a device layer composed of a plurality of devices formed on the front side of said substrate layer and partitioned by a plurality of planned division lines, said laser processing method comprising: a holding step of holding said wafer in the condition where said device layer of said wafer is opposed to said holding surface of said holding means; a processing step of processing said wafer by applying said laser beam to said wafer from the back side along said planned division lines in a defocused condition where the focal position of said laser beam focused by said focusing means is spaced apart from the surface position of said substrate layer of said wafer on the back side by a predetermined distance toward said focusing means; and a dividing step of dividing said wafer into said individual devices along said planned division lines by applying an external force to said wafer.

According to the laser processing method of the present invention, the laser beam is applied to the wafer in the defocused condition where the focal position of the laser beam is spaced apart from the surface position of the substrate layer on the back side by a predetermined distance. Accordingly, the focal point of the laser beam can be formed at a position remote from the device layer, and the energy of the laser beam applied to the wafer can be absorbed more by the substrate layer. As a result, it is possible to reduce the energy of the laser beam not absorbed by the substrate layer, but transmitted through the substrate layer to the device layer and also reduce the energy density of the laser beam.

Preferably, the substrate layer includes a hard-to-grind sapphire substrate layer having a high Mohs hardness.

According to the present invention, it is possible to provide a laser processing method and apparatus which can suppress the damage to the optical devices formed in the device layer of a wafer in applying a laser beam along the streets formed on the substrate layer of the wafer, thereby giving the wafer any means for triggering the division of the wafer by the application of an external force.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a schematic sectional view showing the relation between the focal position of a laser beam and the surface position of the substrate layer of a wafer on the back side thereof in a laser processing method according to the present invention;

FIG. 2 is a schematic sectional view showing a comparison such that a laser beam is applied to the wafer in a just focused condition where the focal position of the laser beam is the same as the surface position of the substrate layer;

FIG. 3 is a schematic sectional view showing another comparison such that a laser beam is applied to the wafer in an inward defocused condition where the focal position of the laser beam is spaced apart from the surface position of the substrate layer inward the wafer;

FIG. 4 is a schematic view for illustrating the configuration of a laser processing apparatus according to the present invention; and

FIG. 5 is a graph showing the result of measurement of the depth of a laser processed groove formed on the substrate layer on the back side thereof by laser processing in the outward defocused condition shown in FIG. 1, the just focused condition shown in FIG. 2, and the inward defocused condition shown in FIG. 3.

### DETAILED DESCRIPTION OF THE PREFERRED EMBODIMENTS

A preferred embodiment of the present invention will now be described with reference to the drawings. The following preferred embodiment is a typical embodiment of the present invention, and the scope of the present invention is not construed narrowly by this preferred embodiment.

### 1. Laser Processing Method

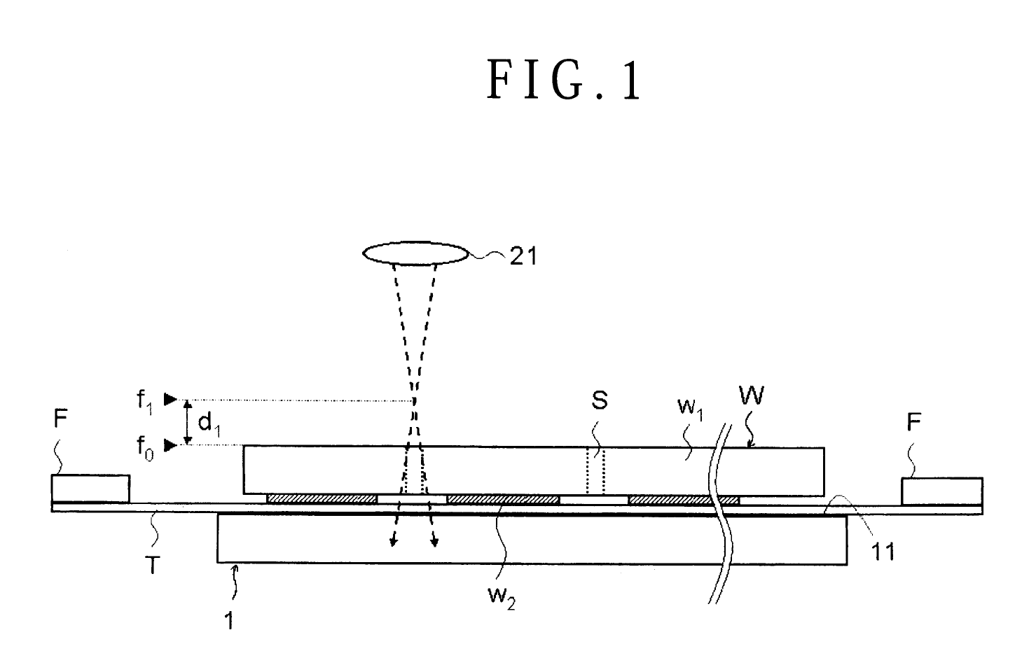

The laser processing method according to the present invention relates to a method of processing a wafer including a substrate layer and a device layer composed of a plurality of devices formed on the front side of the substrate layer by applying a laser beam along a plurality of planned division lines for partitioning the plural devices, and this method is characterized in that the laser beam is applied to the wafer in a defocused condition where the focal position of the laser beam is spaced apart from the surface position of the substrate layer on the back side thereof by a predetermined distance. This laser processing method will now be described more specifically with reference to FIG. 1. FIG. 1 is a schematic sectional view showing the relation between the focal position of the laser beam and the surface position of the substrate layer on the back side thereof in the laser processing method according to the present invention. In this preferred embodiment, the wafer as a workpiece to be processed is an optical device wafer.

Referring to FIG. 1, reference symbol W denotes a wafer. The wafer W includes a substrate layer w1 and a device layer w2 composed of a plurality of optical devices formed on the front side of the substrate layer w1. The substrate layer w1 is formed from a sapphire substrate or a gallium arsenide substrate, for example. Each optical device forming the device layer w2 includes a gallium nitride compound semiconductor layer (EPI layer), for example. The front side of the substrate layer w1 is partitioned into a plurality of regions arranged like a matrix, and the plural optical devices forming the device layer w2 are formed in these plural regions, respectively. The plural optical devices are spaced apart from each other, and the substrate layer w1 has a space region where the optical devices are not formed, wherein this space region is formed as a plurality of planned division lines (see reference symbol S in FIG. 1) to be processed by applying a laser beam for the purposes of dividing the wafer into the individual optical devices. In the following description of the preferred embodiment, the planned division lines S will be referred to as streets S.

### (1) Holding Step

In the laser processing method according to the present invention, the wafer W is first held in the condition where the device layer w2 is opposed to a holding surface of holding means included in a laser processing apparatus. Referring to FIG. 1, reference numeral 1 denotes the holding means of the laser processing apparatus, and reference numeral 11 denotes the holding surface of the holding means 1 for holding the wafer W as a workpiece. The wafer W is attached to a dicing tape T supported to an annular support frame F, and is placed on the holding surface 11 of the holding means 1. The holding means 1 is provided by a chuck table in this preferred embodiment. The dicing tape T is attached to the device layer w2 of the wafer W, and the wafer W is placed on the holding surface 11 of the holding means 1 in the condition where the device layer w2 of the wafer W supported through the dicing tape T to the support frame F is opposed to the holding surface 11. After placing the wafer W on the holding surface 11 of the holding means 1, suction means (not shown) connected to the holding means 1 is operated to hold the wafer W on the holding surface 11 under suction. Further, the support frame F supporting the wafer W through the dicing tape T is fixed by clamps (not shown) provided on the holding means 1.

### (2) Processing Step

Thereafter, a laser beam is applied to the wafer W from the back side thereof along the streets S formed on the substrate layer w1 to thereby form a plurality of laser processed grooves extending along the streets S. In FIG. 1, reference numeral 21 denotes focusing means such as a focusing lens included in laser beam applying means of the laser processing apparatus. The focusing means 21 functions to focus a laser beam (see broken lines in FIG. 1) from the back side of the substrate layer w1 to the wafer W held on the holding means 1 in the condition where the device layer w2 is opposed to the holding surface 11 in applying the laser beam along the streets S formed on the substrate layer w1.

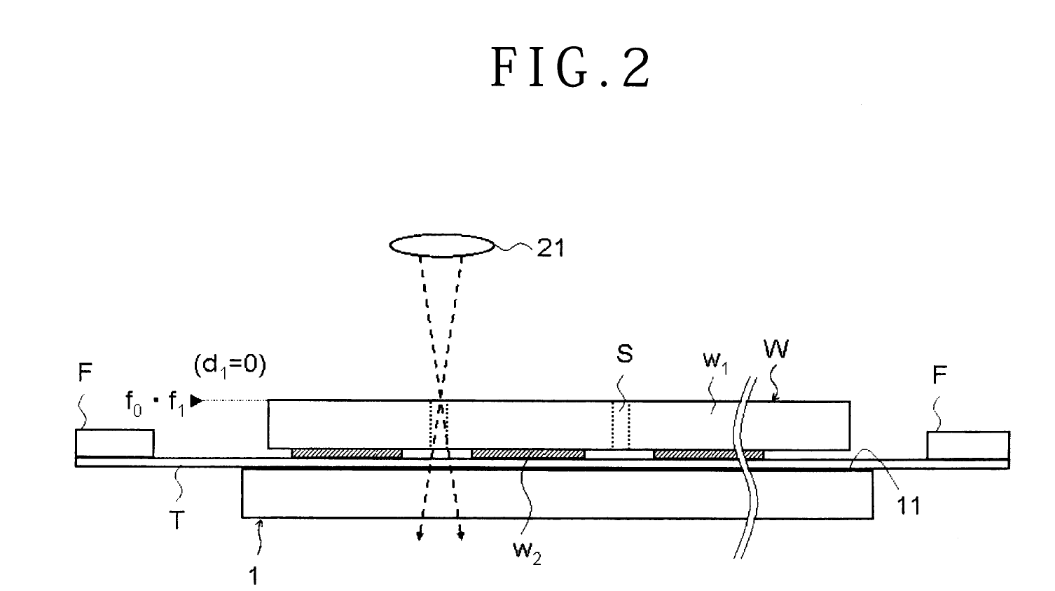

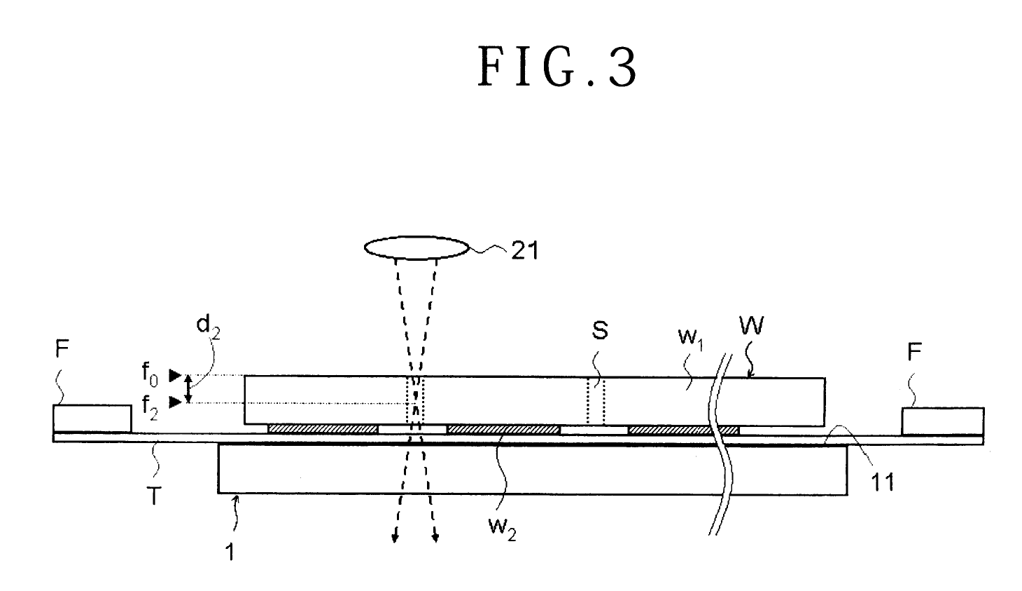

In the laser processing method according to the present invention, the laser beam is applied to the wafer W in an outward defocused condition where the focal position of the laser beam is spaced apart from the surface position of the substrate layer w1 on the back side thereof by a predetermined distance toward the focusing means 21. That is, as shown in FIG. 1, the focal position f1 of the laser beam focused by the focusing means 21 is spaced apart from the surface position f0 of the substrate layer w1 on the back side thereof toward the focusing means 21 by a predetermined distance d1. As a comparison, FIG. 2 shows a case that the laser beam is applied to the wafer W in a just focused condition where the focal position f1 of the laser beam is the same as the surface position f0 of the substrate layer w1 on the back side thereof, that is, the distance d1 is set to zero. As another comparison, FIG. 3 shows a case that the laser beam is applied to the wafer W in an inward defocused condition where the focal position f2 of the laser beam is spaced apart from the surface position f0 of the substrate layer w1 on the back side thereof inward the wafer W (toward the holding means 1) by a distance d2, that is, the focal position f2 is set inside the substrate layer w1 at the depth d2.

By applying the laser beam to the wafer W in the outward defocused condition where the focal position f1 is spaced apart from the surface position f0 of the substrate layer w1 by the distance d1 toward the focusing means 21 as shown in FIG. 1, the focal point of the laser beam can be formed at a position farther from the device layer w2 than that in the comparisons shown in FIGS. 2 and 3. As a result, the laser beam not absorbed by the substrate layer w1, but transmitted through the substrate layer w1 to the device layer w2 can be diffused in a low energy density condition. Further, as described later in detail in Example, the energy of the laser beam applied in the outward defocused condition shown in FIG. 1 can be absorbed by the substrate layer w1 more than the case that the laser beam is applied in the just focused condition shown in FIG. 2. As a result, the laser processed grooves can be formed efficiently and the energy of the laser beam transmitted through the substrate layer w1 to the device layer w2 can be reduced.

According to the laser processing method of the present invention, the energy itself of the laser beam not absorbed by the substrate layer w1, but transmitted through the substrate layer w1 to the device layer w2 can be reduced and the energy density thereof can also be reduced. Accordingly, it is possible to prevent that the optical devices formed in the device layer w2 may be damaged by the laser beam transmitted through the substrate layer w1 to the device layer w2.

The distance d1 between the focal position f1 of the laser beam and the surface position f0 of the substrate layer w1 is required to be suitably set according to the characteristics of the laser beam and the characteristics of the substrate layer w1. For example, the characteristics of the laser beam include wavelength (nm), average power (W), and repetition frequency (Hz). Further, the characteristics of the substrate layer w1 include light transmissivity (%) for the laser beam. Further, an optimum value for the distance d1 may change also according to a processing speed (mm/s) of the laser beam applied along each street S. In the laser processing method according to the present invention, these values for the characteristics of the laser beam and the characteristics of the substrate layer w1 are considered to set the distance d1 that can absorb a maximum amount of energy of the laser beam in the substrate layer w1.

More specifically, in the case that a sapphire substrate is used as the substrate layer w1, and a laser beam having a wavelength of 355 nm, an average power of 0.84 W, and a repetition frequency of 90 kHz is applied along each street S at a processing speed of 55 mm/s to thereby form a laser processed groove, the distance d1 is set in a preferable range of about 5 to 20 μm. While the laser beam is applied along each street S to form a laser processed groove in this preferred embodiment, a modified region may be formed along each street S by applying a laser beam provided that the modified region can trigger the division (break) of the wafer by the application of an external force in the subsequent dividing step.

### (3) Dividing Step

Finally, an external force is applied to the wafer W to divide the wafer W along the streets S subjected to the laser processing mentioned above, thus obtaining the individual optical devices. In the case that a laser processed groove is formed along each street S, an external force is applied along this laser processed groove to thereby cleave the wafer W. In the case that a modified region is formed along each street S, the strength of the modified region is smaller than that of the other region, so that an external force is applied along each street S to thereby trigger the division of the wafer W in the modified region.

According to the laser processing method of the present invention, it is possible to prevent that the optical devices formed in the device layer of the wafer may be damaged by the laser beam transmitted through the substrate layer to the device layer prior to the dividing step. This laser processing method is preferably adopted for the division of LED (Light Emitting Diode) devices formed by using a hard-to-grind sapphire substrate having a high Mohs hardness.

### 2. Laser Processing Apparatus

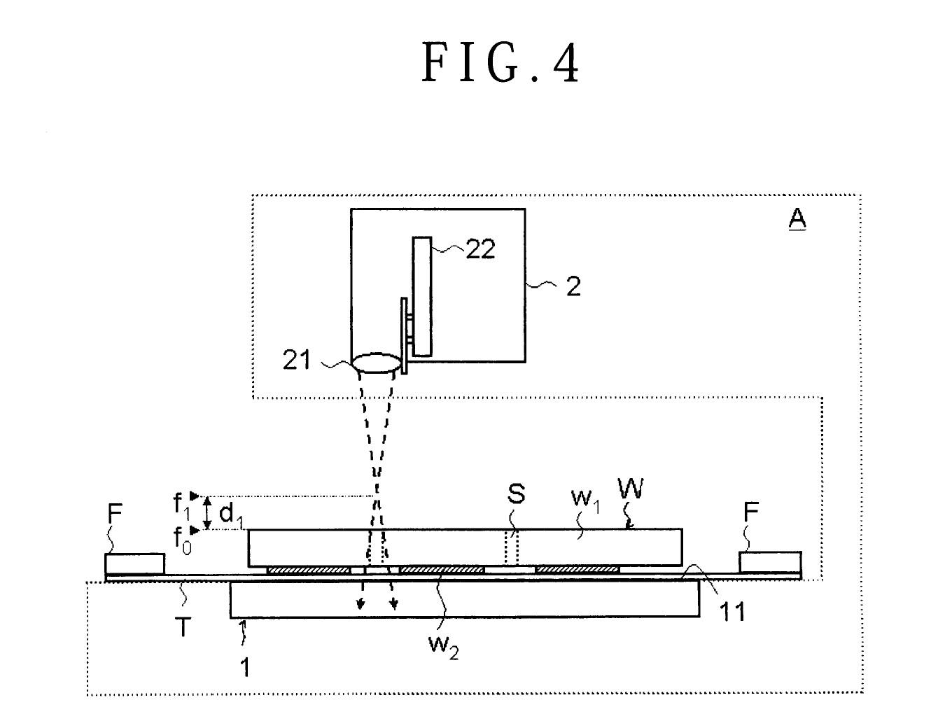

The laser processing apparatus according to the present invention relates to an apparatus for processing a wafer including a substrate layer and a device layer composed of a plurality of devices formed on the front side of the substrate layer by applying a laser beam along a plurality of planned division lines for partitioning the plural devices, and this apparatus is characterized in that it includes focal position control means for applying the laser beam to the wafer in a defocused condition where the focal position of the laser beam is spaced apart from the surface position of the substrate layer on the back side thereof by a predetermined distance. The configuration of this laser processing apparatus will now be described with reference to FIG. 4. FIG. 4 is a schematic view for illustrating the configuration of a laser processing apparatus A according to the present invention.

The laser processing apparatus A includes holding means 1 for holding a wafer W supported through a dicing tape T to an annular support frame F in the condition where the device layer w2 of the wafer W is opposed to the holding surface 11 of the holding means 1 (see also FIG. 1). The holding means 1 is provided by a chuck table in this preferred embodiment, and it includes suction means (not shown) for holding the wafer W on the holding surface 11 under suction and clamps (not shown) for fixing the support frame F supporting the wafer W through the dicing tape T.

The laser processing apparatus A further includes laser beam applying means 2 for applying a laser beam (see broken lines in FIG. 4) to the wafer W held on the holding means 1 to thereby form a laser processed groove. The laser beam applying means 2 is located above the holding means 1. The laser beam applying means 2 includes focusing means 21 for focusing the laser beam to apply it along each street S from the substrate layer w1 side, i.e., from the back side of the wafer W. The focusing means 21 is provided by a focusing lens, for example. The laser beam applying means 2 further includes a laser oscillator such as a YAG laser oscillator or a YVO4 laser oscillator for generating a laser beam having an absorption wavelength to the substrate layer w1 and a mirror constituting an optical path.

The laser processing apparatus A further includes focal position control means 22 as a component of the laser beam applying means 2 as shown in FIG. 4. The focal position control means 22 is provided by feeding means capable of moving the focusing means (focusing lens) 21 in a laser beam applying direction (vertical direction as viewed in FIG. 4). More specifically, this feeding means includes a ball screw and a motor as commonly used. The focal position control means 22 functions to defocus the laser beam at a position spaced apart from the surface position of the substrate layer w1 by a predetermined distance in applying the laser beam from the focusing means 21 to the wafer W. That is, the focal position control means 22 controls the focal position (see reference symbol f1 in FIG. 4) of the laser beam focused by the focusing means 21 to a position spaced apart from the surface position (see reference symbol f0 in FIG. 4) of the substrate layer w1 on the back side thereof by a predetermined distance (see reference symbol d1 in FIG. 4) toward the focusing means 21.

The focal position f1 is adjusted by suitably setting the distance d1 from the surface position f0 of the substrate layer w1 according to the characteristics of the laser beam and the characteristics of the substrate layer w1. Optimum set values for the distance d1 may be preliminarily stored in the focal position control means 22 according to the characteristics of the laser beam and the characteristics of the substrate layer w1. The focal position control means 22 refers to these set values for the distance d1 and selects a suitable one of these set values according to the characteristics of the substrate layer w1 and the characteristics of the laser beam. Accordingly, the distance d1 can be set to such a value that the energy of the laser beam applied can be absorbed more by the substrate layer w1.

By controlling the distance d1 by the focal position control means 22 included in the laser processing apparatus A, the focal point of the laser beam can be formed at a position remote from the device layer w2, so that the laser beam not absorbed by the substrate layer w1, but transmitted through the substrate layer w1 to the device layer w2 can be diffused in a low energy density condition (see also FIGS. 2 and 3). According to the laser processing apparatus A, the energy itself of the laser beam not absorbed by the substrate layer w1, but transmitted through the substrate layer w1 to the device layer w2 can be reduced and the energy density thereof can also be reduced. Accordingly, it is possible to prevent that the optical devices formed in the device layer w2 may be damaged by the laser beam transmitted through the substrate layer w1 to the device layer w2.

While a laser processed groove is formed along each street S by the laser processing apparatus A in this preferred embodiment, a modified region may be formed instead of the laser processed groove as mentioned above.

### Example

In Example, a study was made on the distance between the focal position of a laser beam and the surface position of the substrate layer of a wafer on the back side thereof in order to determine a proper distance range allowing the minimization of the energy of the laser beam transmitted through the substrate layer to the device layer of the wafer.

The study was made under the following conditions.

### (1) Processing Apparatus

An automatic laser saw DFL7160 manufactured by Disco Corporation was used to apply a laser beam having a wavelength of 355 nm, an average power of 0.84 W, and a repetition frequency of 90 kHz to a wafer at different processing speeds of 110, 80, and 55 mm/s.

### (2) Wafer

A sapphire substrate (SA100, 2 inches in diameter, 90 μm in thickness) manufactured by Kyocera Corporation was used.

### (3) Defocusing Conditions

The study was made in the just focused condition where the focal position of the laser beam coincides with the surface position of the wafer on the back side thereof (see FIG. 2), in the outward defocused condition where the focal position is spaced apart from the surface position toward the focusing means 21 in increments of 5 μm (see FIG. 1), and in the inward defocused condition where the focal position is spaced apart from the surface position inward the wafer (toward the holding means 1) in increments of 5 μm (see FIG. 3).

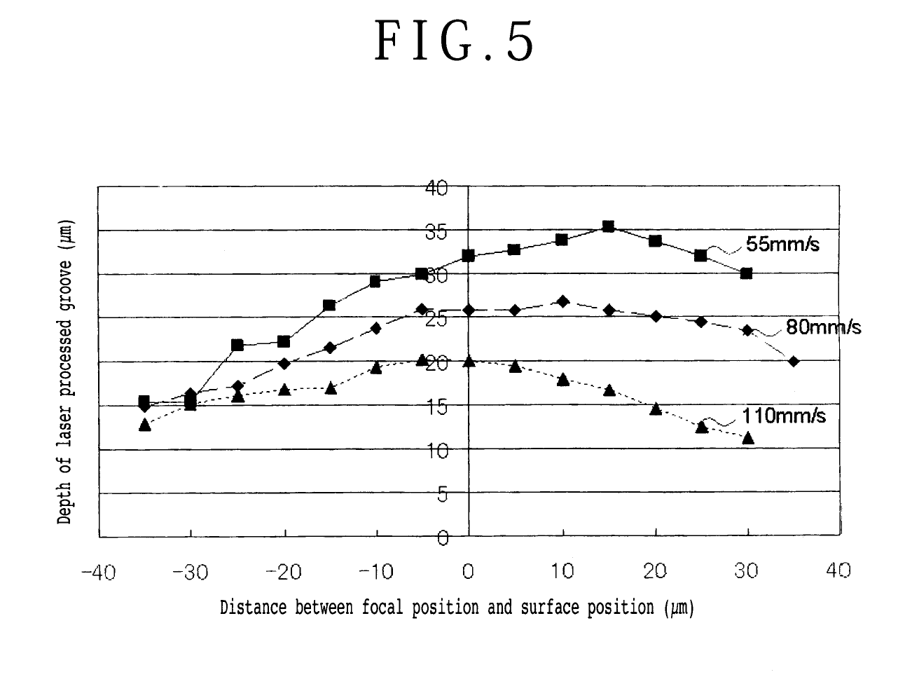

In the just focused condition, the outward defocused condition, and the inward defocused condition, the laser beam was applied to the wafer at the different processing speeds mentioned above to form laser processed grooves having different depths from the back side of the wafer. These different depths were measured as “depth of laser processed groove.” The result of measurement is shown in FIG. 5. In FIG. 5, the horizontal axis represents the distance (μm) between the focal position of the laser beam and the surface position of the wafer on the back side thereof. Positive values along the horizontal axis correspond to the outward defocused condition where the focal position is spaced apart from the surface position toward the focusing means 21, whereas negative values along the horizontal axis correspond to the inward defocused condition where the focal position is spaced apart from the surface position inward the wafer (toward the holding means 1). Further, in FIG. 5, the vertical axis represents the depth of laser processed groove (μm).

In the just focused condition where the focal position of the laser beam coincides with the surface position of the wafer on the back side thereof, i.e., the distance between the focal position and the surface position is set to 0, the depth of laser processed groove at the processing speed of 55 mm/s was about 32 μm. To the contrary, in the outward defocused condition where the focal position is spaced apart from the surface position by 15 μm (see FIG. 1), the depth of laser processed groove was increased to about 35 μm. The energy intensity of the laser beam in the just focused condition was the same as that in the outward defocused condition, so that it is considered that the energy of the laser beam applied could be absorbed by the wafer more in the case that the distance between the focal position and the surface position was set to 15 μm, thereby increasing the depth of laser processed groove. This increase in amount of energy of the laser beam absorbed by the wafer means a decrease in amount of energy of the laser beam transmitted through the wafer.

As shown in FIG. 5, an increase in depth of laser processed groove in the outward defocused condition was absorbed in the case that the distance between the focal position and the surface position was set to 5 to 20 μm. On the other hand, in the outward defocused condition where the distance between the focal position and the surface position was set to 30 μm or more, the depth of laser processed groove was smaller than that in the just focused condition, causing a reduction in processing efficiency. This result was observed also in the inward defocused condition.

As apparent from the above result, by setting the distance between the focal position and the surface position to about 5 to 20 μm at the processing speed of 55 mm/s, the laser processing can be efficiently performed and the energy of the laser beam transmitted through the wafer can be reduced. At the processing speed of 80 mm/s, an increase in depth of laser processed groove was observed only in the outward defocused condition where the distance between the focal position and the surface position was set to 10 μm. Further, at the processing speed of 110 mm/s, no increase in depth of laser processed groove was observed in any defocused condition.

As apparent from these results, by suitably setting the distance between the focal position of the laser beam and the surface position of the substrate layer of the wafer on the back side thereof, the energy of the laser beam transmitted through the substrate layer can be minimized and the energy density of the laser beam can also be reduced. Further, it was suggested that an optimum distance between the focal position of the laser beam and the surface position of the substrate layer must be set according to the processing speed.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing method using a laser processing apparatus including holding means having a holding surface for holding a wafer and laser beam applying means having focusing means for applying a laser beam to the wafer held by said holding means, said wafer including a substrate layer, and a device layer composed of a plurality of devices formed on the front side of said substrate layer and partitioned by a plurality of planned division lines,
said laser processing method comprising:
a holding step of holding said wafer in the condition where said device layer of said wafer is opposed to said holding surface of said holding means;
a processing step of processing said wafer by applying said laser beam to said wafer from the back side along said planned division lines in a defocused condition where the focal position of said laser beam focused by said focusing means is spaced apart from the surface position of said substrate layer of said wafer on the back side by a predetermined distance toward said focusing means; and
a dividing step of dividing said wafer into said individual devices along said planned division lines by applying an external force to said wafer.

2. The laser processing method according to claim 1, wherein said substrate layer comprises a sapphire substrate layer.
